(19) United States
(12) Patent Application Publication
(10) Pub. No.: US 2025/0221334 A1
(43) Pub. Date: Jul. 10, 2025

(54) Extended Life Mower Blade

(71) Applicant: Husqvarna AB, Huskvarna (SE)

(72) Inventor: John Southwell, Huntersville, NC (US)

(21) Appl. No.: 18/835,191

(22) PCT Filed: Feb. 2, 2022
(86) PCT No.: PCT/US2022/014856

§ 371 Date: Aug. 1, 2024

(51) Int. Cl. A01D 34/73; A01D 34/82

(52) U.S. Cl. CPC A01D 34/73; A01D 34/82

(57) ABSTRACT

Mower blades are provided, in which the mower blades include a body portion formed from a base metal layer having a first hardness, and having a first end including a first side edge and a first leading edge including a first cutting edge arranged opposite a first trailing edge and a second end including a second side edge and a second leading edge including a second cutting edge arranged opposite a second trailing edge. The mower blades also include a hard-facing material having a second hardness that is disposed on the first cutting edge, the second cutting edge, and at least a portion of a top surface of the body portion of the mower blades, in which the second hardness is larger than the first hardness.

### TECHNICAL FIELD

Embodiments of the presently-disclosed invention relate generally to mower blades including a hard-facing material (e.g., a tungsten carbide-containing coating) deposited onto a plurality of high wear areas of the mower blades.

### BACKGROUND

Various type of rotary lawn mowers, such as walk-behind lawn mowers, rider mowers, or robotic lawn mowers, are used for garden or lawn maintenance. Typically, a rotary lawn mower includes one or more mower blades which are arranged to rotate about a vertical axis and provide cutting action. The mower blades, for example, may be attached to a rotating carrier member, such that the rotating carrier member is powered by a prime mover (e.g., motor or other power supply) to rotate the mower blades. Generally, a mower blade includes a cutting edge arranged to cut the grass.

Typical lawn mower maintenance includes sharpening the mower blades frequently and eventually replacing them a few times of the life of the lawn mower. Both of these maintenance activities can be costly to the owner. Additionally, in some instances the structural integrity of the mower blade becomes weak or insufficient for efficient and/or safe use in mowing application.

In this regard, there remains a need in the art for an improved mower blade having an extended life.

### SUMMARY OF INVENTION

Certain example embodiments according to the invention provide a mower blade including a body portion formed from a base metal layer having a first hardness. The body portion may include a top surface, a bottom surface, a first side edge, a second side edge, and an aperture configured to mount the mower blade to a rotary power output of a mower to provide the body rotary movement, in which the aperture divides the body portion into a first end and a second end. The first end may include the first side edge and a first leading edge including a first cutting edge arranged opposite a first trailing edge, in which the first trailing edge has a first upturned portion. The second end may include the second side edge and a second leading edge including a second cutting edge arranged opposite a second trailing edge, in which the second trailing edge having a second upturned portion. The mower blade may also include a hard-facing material having a second hardness and disposed on the first cutting edge, the second cutting edge, and at least a portion of the top surface, in which the second hardness is larger than the first hardness.

In another example embodiment, a lawn mower is provided. The lawn mower may include a motor (e.g., gas powered, electrically powered, or battery powered) coupled to a rotary power output that is coupled to a mower blade, such as those described and disclosed herein. For instance, the mower blade may include a body portion formed from a base metal layer having a first hardness. The body portion may include a top surface, a bottom surface, a first side edge, a second side edge, and an aperture configured to mount the mower blade to a rotary power output of a mower to provide the body rotary movement, in which the aperture divides the body portion into a first end and a second end. The first end may include the first side edge and a first leading edge including a first cutting edge arranged opposite a first trailing edge, in which the first trailing edge has a first upturned portion. The second end may include the second side edge and a second leading edge including a second cutting edge arranged opposite a second trailing edge, in which the second trailing edge having a second upturned portion. The mower blade may also include a hard-facing material having a second hardness and disposed on the first cutting edge, the second cutting edge, and at least a portion of the top surface, in which the second hardness is larger than the first hardness.

In another example embodiment, a method of producing a mower blade is provided. The method of producing a mower blade may include providing or forming a body portion from a base metal layer having a first hardness, in which the body portion includes a top surface, a bottom surface, a first side edge, a second side edge, and an aperture configured to mount the mower blade to a rotary power output of a mower to provide the body rotary movement, the aperture dividing the body portion into a first end and a second end. The first end may include the first side edge and a first leading edge including a first cutting edge arranged opposite a first trailing edge, in which the first trailing edge having a first upturned portion. The second end may include the second side edge and a second leading edge including a second cutting edge arranged opposite a second trailing edge, in which the second trailing edge having a second upturned portion. The method may also include a step of depositing (e.g., coating) a hard-facing material having a second hardness on the first cutting edge, the second cutting edge, and at least a portion of the top surface, in which the second hardness is larger than the first hardness to produce a mower blade, such as those described and disclosed herein.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a top plan view of an example mower blade according to an example embodiment;

FIG. 2 illustrates a front view of the example mower blade of FIG. 1;

FIG. 3 illustrates a side edge view of an example mower blade according to an example embodiment.

FIG. 4 illustrates a perspective view of an example walking style lawn mower;

FIG. 5 illustrates a perspective view of the bottom side of the example walking style lawn mower of FIG. 4, and illustrates the connection of a mower blade.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling or the term “coupled” should be understood to relate to direct or indirect connection that, in either case, enables functional interconnection of components that are operably coupled to each other.

Certain example embodiments provide mower blades that may be used for a noticeably longer time in active mowing applications compared to traditional mower blades. In this regard, certain example mower blades may reduce the amount of time spent on maintenance activities and offer a lower overall operating cost for an owner. Certain example mower blades, for example, may include a hard-facing material disposed (e.g., coated) onto one or more high wear areas of the mower blade due to mowing applications. For example, the hard-facing material may be applied to the cutting edge(s), the side edge(s), and at least a portion of the top surface (e.g., the surface proximate to the mower body during operation in accordance with the mower blades intended use) of the mower blade.

In one aspect, certain example embodiments provide a mower blade including a body portion formed from a base metal layer having a first hardness. The body portion may include a top surface, a bottom surface, a first side edge, a second side edge, and an aperture configured to mount the mower blade to a rotary power output of a mower to provide the body rotary movement, in which the aperture divides the body portion into a first end and a second end. The first end may include the first side edge and a first leading edge including a first cutting edge arranged opposite a first trailing edge, in which the first trailing edge has a first upturned portion. The second end may include the second side edge and a second leading edge including a second cutting edge arranged opposite a second trailing edge, in which the second trailing edge having a second upturned portion. The mower blade may also include a hard-facing material having a second hardness and disposed on the first cutting edge, the second cutting edge, and at least a portion of the top surface, in which the second hardness is larger than the first hardness.

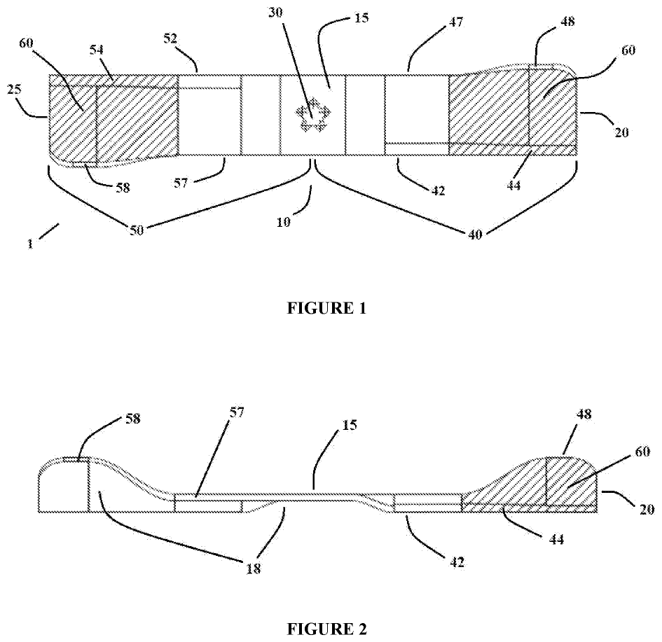

FIG. 1, for instance, illustrates a mower blade 1 including a body portion 10 formed from a base metal layer having a first hardness. The body portion 10, as shown in FIG. 1, may include a top surface 15, a bottom surface 18 (shown in FIG. 2), a first side edge 20, a second side edge 25, and an aperture 30 configured to mount the mower blade to a rotary power output of a mower to provide the body rotary movement, in which the aperture divides the body portion into a first end 40 and a second end 50. The first end 40 may include the first side edge 20 and a first leading edge 42 including a first cutting edge 44 arranged opposite a first trailing edge 47, in which the first trailing edge has a first upturned portion 48. In this regard, for example, the first cutting edge 44 may be considered a sub-section of portion of the first leading edge 42, in which the first cutting edge has been sharpened to facilitate the ability of the mower blade to cut a variety of vegetation (e.g., grass, weeds, etc.). The second end 50 may include the second side edge 25 and a second leading edge 52 including a second cutting edge 54 arranged opposite a second trailing edge 57, in which the second trailing edge having a second upturned portion 58. In this regard, for example, the second cutting edge 54 may be considered a sub-section of portion of the second leading edge 52, in which the first cutting edge has been sharpened to facilitate the ability of the mower blade to cut a variety of vegetation (e.g., grass, weeds, etc.). The mower blade 1 may also include a hard-facing material 60 having a second hardness, in which the hard-facing material may be disposed on the first cutting edge 44, the second cutting edge 54, and/or at least a portion of the top surface 18, and/or, the first side edge 20, and/or the second side edge 25, and/or the at least a portion of the bottom surface 18 (not shown). The hard-facing material has a second hardness that is larger than the first hardness. In this regard, the base metal layer may be softer and more easily damaged during operation of the mower blade in comparison to the hard-facing material.

FIG. 2 illustrates a front view of the example mower blade of FIG. 1. FIG. 2 better illustrates the opposing faces of the top surface 15 and the bottom surface 18, as well as the upturned portions 48, 58. The first upturned portion 48 and the top surface 15 may define a first uplift portion and the second upturned portion 58 and the top surface 15 may define a second upturned portion. In this regard, the uplift portions facilitate the mower blade's ability to pull, for example, grass clipping up into the deck of an associated lawn mower and expel them for side discharge or bagging. For example, the uplift portions provide a lift or suction that may keep grass clippings circulating under the deck for mulching if so desired. As also shown in the FIG. 2, the first cutting edge 44 of the first leading edge 42 may be more sharpened relative to the portion of the leading edge proximate the aperture. In accordance with certain example embodiments, the first cutting edge 44 and/or the second cutting edge 54 may be tapered in a narrowing manner towards the respective side edge. For example, the first cutting edge 44 may include a first thickness proximate and/or adjacent the first side edge 20 and a second thickness distal from the first side edge 20. In a similar manner, the second cutting edge 54 may include a second thickness proximate and/or adjacent the second side edge 25 and a second thickness distal from the second side edge 25.

In accordance with certain example embodiments, the hard-facing material may be disposed the first cutting edge, the second cutting edge, at least a portion of the top surface, optionally on the first side edge, and optionally on the second side edge. In certain example embodiments, the mower blade may include a first distance between the aperture and the first side edge that defines a first length, in which the hard-facing material may be disposed on the top surface and defines a first coating area extending from the first leading edge (which includes the first cutting edge) to the first trailing edge and from the first side edge inwardly towards the aperture along 10% to 100% of the first length, such as at least about any of the following: 10, 15, 20, 25, 30, 35, 40, 45, 50, 55, and 60% of the first length, and/or at most about any of the following: 100, 95, 90, 85, 80, 75, 70, 65, and 60% of the first length. Additionally or alternatively, the mower blade may include a second distance between the aperture and the second side edge defines a second length, in which the hard-facing material is disposed on the top surface and defines a second coating area extending from the second leading edge (which includes the first cutting edge) to the second trailing edge and from the second side edge inwardly towards the aperture along 10% to 100% of the second length, such as at least about any of the following: 10, 15, 20, 25, 30, 35, 40, 45, 50, 55, and 60% of the second length, and/or at most about any of the following: 100, 95, 90, 85, 80, 75, 70, 65, and 60% of the second length. In this regard, the entirety of the top surface by be coated with the hard-facing material in certain example embodiments, while in other example embodiments only a defined percentage of the top surface may be coated with the hard-facing material to provide a sufficiently robust or long-lasting mower blade in relation to the average life of a lawn mower as an economical alternative.

In accordance with certain example embodiments, the top surface of the mower blade may include a first top surface portion, in which the first top surface portion and the first upturned portion define a first lift portion as noted above. In certain example embodiments, from about 10 to about 100% of the first top surface portion has the hard-facing material disposed thereon, such as at least about any of the following: 10, 15, 20, 25, 30, 35, 40, 45, 50, 55, and 60% of the first top surface portion has the hard-facing material disposed thereon, and/or at most about any of the following: 100, 95, 90, 85, 80, 75, 70, 65, and 60% of the first top surface portion has the hard-facing material disposed thereon. Additionally or alternatively, the top surface of the mower blade may include a second top surface portion, in which the second top surface portion and the second upturned portion define a second lift portion as noted above. In certain example embodiments, from about 10 to about 100% of the second top surface portion has the hard-facing material disposed thereon, such as at least about any of the following: 10, 15, 20, 25, 30, 35, 40, 45, 50, 55, and 60% of the second top surface portion has the hard-facing material disposed thereon, and/or at most about any of the following: 100, 95, 90, 85, 80, 75, 70, 65, and 60% of the second top surface portion has the hard-facing material disposed thereon.

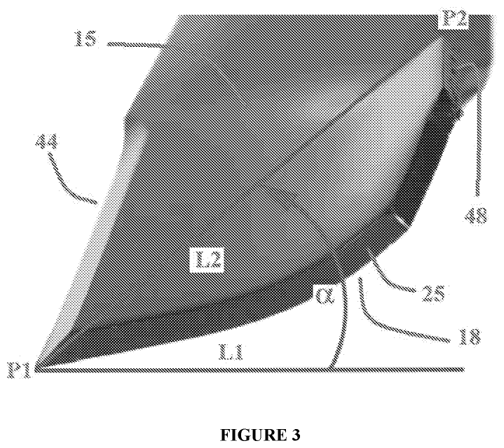

In accordance with certain example embodiments and as illustrated by FIG. 3, the first uplift portion may have a first uplift angle (α) of 20 to 60 degrees as measured from (i) a first imaginary line (L1) that starts at a first point (P1) defined by the intersection of the first cutting edge 44 and the first side edge 25 and extends towards the first trailing edge along an imaginary plane that is parallel to a planar central body portion surrounding the aperture of the body portion, and (ii) a second imaginary line (L2) that starts at the first point (P1) and extends in a straight path to an uppermost point (P2) of the first upturned portion 48. In certain example embodiments, the first uplift angle (α) may, for example, comprise at least about any of the following: 20, 25, 30, and 35 degrees, and/or at most about any of the following: 60, 55, 50, 45, 40, and 35 degrees. Additionally or alternatively, the second uplift portion may have a second uplift angle (α) that is the same as the first uplift angle, such as at least about any of the following: 20, 25, 30, and 35 degrees, and/or at most about any of the following: 60, 55, 50, 45, 40, and 35 degrees.

In accordance with certain example embodiments, the first cutting edge may extend inwardly from the first side edge and comprises from 10 to about 70% of first leading edge. In certain example embodiments, the hard-facing material is disposed onto the first cutting edge, such as the entirety of the first cutting edge. For example, the first cutting edge may extend inwardly from the first side edge and comprise at least about any of the following: 10, 15, 20, 25, 30, and 35% of the first leading edge, and/or at most about any of the following: 70, 65, 60, 55, 50, 45, 40, and 35% of the first leading edge. Additionally or alternatively, the second cutting edge may extend inwardly from the second side edge and comprise from 10 to about 70% of second leading edge. In certain example embodiments, the hard-facing material is disposed onto the second cutting edge, such as the entirety of the second cutting edge. For example, the second cutting edge may extend inwardly from the second side edge and comprise at least about any of the following: 10, 15, 20, 25, 30, and 35% of the second leading edge, and/or at most about any of the following: 70, 65, 60, 55, 50, 45, 40, and 35% of the second leading edge.

The hard-facing material, in accordance with certain example embodiments, may have an average thickness from about 50 microns to about 3000 microns, such as at least about any of the following: 50, 100, 125, 150, 175, 200, 300, 400, 500, 800, and 1000 microns, and/or at most about any of the following: 3000, 2500, 2000, 1800, 1500, 1200, and 1000 microns.

In accordance with certain example embodiments, the hard-facing material deposited onto the first cutting edge, the second cutting edge or both has a first average thickness and the hard-facing material deposited onto the top surface of the first uplift portion (e.g., the portion including a upturned curvature towards the first trailing edge), the second uplift portion (e.g., the portion including a upturned curvature towards the first trailing edge), or both has a second average thickness, in which the first average thickness is the same or larger than the second average thickness. In certain example embodiments, the mower blade includes a first ratio between the first average thickness and the second average thickness from 1:1 to 10:1, such as at least about any of the following: 1:1, 1.5:1, 2:1, 4:1, and 5:1, and/or at most about any of the following: 10:1, 9:1, 8:1, 7:1, 6:1, and 5:1. Additionally are alternatively, the hard-facing material deposited on portions of the top surface that are parallel or generally parallel to the ground (e.g., flat portions of the top surface of the mower blade) may have a third average thickness that is smaller than the first average thickness, the second average thickness or both. In certain example embodiments, the mower blade includes a second ratio between the second average thickness and the third average thickness from 1:1 to 10:1, such as at least about any of the following: 1:1, 1.5:1, 2:1, 4:1, and 5:1, and/or at most about any of the following: 10:1, 9:1, 8:1, 7:1, 6:1, and 5:1. In this regard, top surface portions associated with the uplift portions may be exposed to higher wear due, for example, to being oriented at a large angle (α) to the flow of media being cut. As such, a coating of the hard-facing material on surfaces that are parallel to the ground and/or the flow of media being cut may be thinner than a coating of the hard-facing material deposited on the uplift portions. Additionally or alternatively, the hard-facing material deposited onto the first side edge, the second side edge or both has a fourth average thickness, in which the first average thickness is the same or larger than the fourth average thickness. In certain example embodiments, the mower blade includes a third ratio between the first average thickness and the fourth average thickness from 1:1 to 10:1, such as at least about any of the following: 1:1, 1.5:1, 2:1, 4:1, and 5:1, and/or at most about any of the following: 10:1, 9:1, 8:1, 7:1, 6:1, and 5:1. In this regard, the hard-facing material deposited as a coating onto the base metal layer may not be uniform over the external surfaces of the base metal layer, in which high wear areas (e.g., cutting edges and the uplift portions) may have thicker average thicknesses of the hard-facing material as compared to relatively low wear areas.

In accordance with certain example embodiments, the base metal layer may comprise a steel composition, which may optionally be heat treated to enhance hardness and toughness. For example, the steel can be austempered to a bainitic microstructure. In certain example embodiments, the steel composition forming the base metal layer may be a boron-containing steel composition, while the hard-facing material may comprises a nickel-based composition, a, cobalt-based composition, or iron-based composition that may include alloy elements in individual amounts of 0.1-20% by weight of boron, silicon, chromium, iron (for nickel- and cobalt-based alloys), carbon, manganese, nickel (for iron- and cobalt-based alloys), tungsten and combinations thereof. For example, the hard-facing material may comprise a composition including tungsten carbide, tungsten carbide having a cobalt content, boron carbide, nickel bonded carbide, stellite, titanium carbide, chrome carbide, iron carbide, diamond, ceramics, or combinations thereof. In further examples, the hard-facing material may comprise a hard-facing composition as set forth in the non-exhaustive example compositions listed in Table 1.

TABLE 1
Example Compositions 1-4, by weight percentage.

Example

| Element | 1 | 2 | 3 | 4 |
|---|---|---|---|---|
| Boron | 3 | 3.29 | 3.08 | 2 |
| Carbon | 0.7 | 2.18 | 1.98 | 0.6 |
| Chromium | 14.3 | 14.44 | 14.12 | 12.35 |
| Cobalt | — | — | — | Bal. |
| Iron | 4 | Bal. | Bal. | 1.3 |
| Manganese | — | 0.31 | 0.5 | — |
| Nickel | Bal. | 5.72 | 5.64 | 23.5 |
| Silicon | 4.25 | 3.09 | 2.74 | 1.9 |
| Tungsten | — | — | — | 7.6 |

In certain example embodiments, the first hardness H1 (hardness Vickers) and the second hardness H2 (hardness Vickers) define a hardness ratio of H2/H1 from 1.1:1 to 5:1, such as at least about any of the following: 1.1:1, 1.5:1, 2:1, and 2.5:1, and/or at most about 5:1, 4.5:1, 4:1, 3.5:1, 3:1, and 2.5:1. Additionally or alternatively, the second hardness H2 may be no less than 700 HV (Vickers hardness) (e.g., 700-1300 HV) and the first hardness H1 may range from 300-600 HV.

In certain example embodiments, the mower blade may have an extended life compared to an identical mower blade that is devoid of a hard-facing material disposed on the top surface and/or side edges. For example, the average blade life may generally be considered to be 50 hours before requiring replacing and the owner uses the lawn mower for a total of 500 hours, this would require 10 sets of blades (e.g., 1 original blade and 9 replacement blades) over the life of the lawn mower. In certain example embodiments, for instance, the average life of the mower blade may be from 600 to 850 hours, such as at least about any of the following: 600, 625, 650, 675, and 700 hours, and/or at most about any of the following: 850, 825, 800, 775, 750, 725, and 700 hours. In this regard, the mower blades in accordance with certain example embodiments may well outlast the typical operational life span of a typical lawn mower. In certain example embodiments, the life span of the mower blade may be determined when a majority of the first uplift portion, the second uplift portion or both has worn away, such as when at least about any of the following: 40, 45, 50, 55, 60, 65, 70, 75, 80, 85, and 90% of the first uplift portion, the second uplift portion or both has worn away. For example, certain example mower blades may have a useable life compared to an identical mower blade that is devoid of a hard-facing material disposed on the top surface and/or side edges that is at least 5 times longer, such as at least about any of the following: 5, 6, 8, and 10 times longer, and/or at most about any of the following: 15, 14, 13, 12, 11, and 10 times longer.

In another example embodiment, a lawn mower is provided. The lawn mower may include a motor (e.g., gas powered, electrically powered, or battery powered) coupled to a rotary power output that is coupled to a mower blade, such as those described and disclosed herein. For instance, the mower blade may include a body portion formed from a base metal layer having a first hardness. The body portion may include a top surface, a bottom surface, a first side edge, a second side edge, and an aperture configured to mount the mower blade to a rotary power output of a mower to provide the body rotary movement, in which the aperture divides the body portion into a first end and a second end. The first end may include the first side edge and a first leading edge including a first cutting edge arranged opposite a first trailing edge, in which the first trailing edge has a first upturned portion. The second end may include the second side edge and a second leading edge including a second cutting edge arranged opposite a second trailing edge, in which the second trailing edge having a second upturned portion. The mower blade may also include a hard-facing material having a second hardness and disposed on the first cutting edge, the second cutting edge, and at least a portion of the top surface, in which the second hardness is larger than the first hardness.

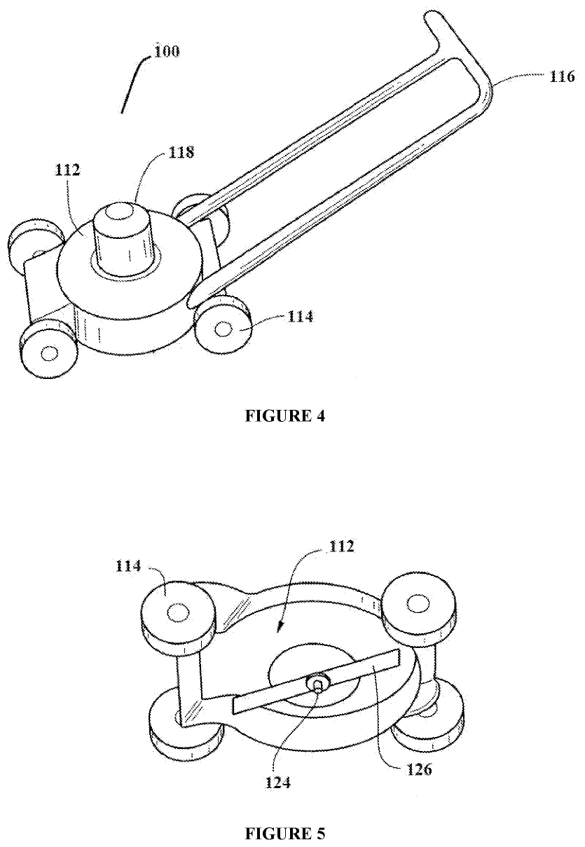

FIG. 4, for instance, illustrates a standard push-type lawn mower typically used for residential purposes. The lawn mower 100 includes a main body portion (e.g., a deck) 112, to which is secured a mower blade (shown in FIG. 5), such as those described and disclosed rein, a plurality of wheels 114, a handle 116, and an engine 118. FIG. 5 illustrates the bottom of the lawn mower 100. Attached to the underside of the main body 112 is a rotary mower blade 126, such as the mower blade as described and disclosed herein. The mower blade 126 is secured to the engine 118 through shaft 124 and fastening elements (not shown).

In another example embodiment, a method of producing a mower blade is provided. The method of producing a mower blade may include providing or forming a body portion from a base metal layer having a first hardness, in which the body portion includes a top surface, a bottom surface, a first side edge, a second side edge, and an aperture configured to mount the mower blade to a rotary power output of a mower to provide the body rotary movement, the aperture dividing the body portion into a first end and a second end. The first end may include the first side edge and a first leading edge including a first cutting edge arranged opposite a first trailing edge, in which the first trailing edge having a first upturned portion. The second end may include the second side edge and a second leading edge including a second cutting edge arranged opposite a second trailing edge, in which the second trailing edge having a second upturned portion. The method may also include a step of depositing (e.g., coating) a hard-facing material having a second hardness on the first cutting edge, the second cutting edge, and at least a portion of the top surface, in which the second hardness is larger than the first hardness to produce a mower blade, such as those described and disclosed herein.

The step of depositing the hard-facing material as a coating onto the desired portions of the base metal layer may be conducted by a variety of operations, such as, by mixing a powdered metal alloy with certain solvents to form a slurry, which may then be applied to the desired portions of the base metal layer of the mower blade. The mower blade may then be heated to cause the metal alloy to adhere to the base metal layer. Other deposition techniques, for example, may include high velocity oxygen formation (HVOF). HVOF typically includes injecting the hard-facing metal alloy in powder or solid form into a high temperature high velocity flame. The flame accelerates the metal particles toward the base metal layer and melts the hard-facing onto the surface of the base metal layer. In certain example embodiments, the hard-facing material may be coated onto the desired portions of the base metal layer by a vapor deposition technique, such as chemical vapor deposition (CVD) or atomic layer deposition (ALD) techniques, which include a number of derivative versions of either of these, such as UV laser photo-dissociation CVD, plasma-assisted CVD, and plasma-assisted ALD, among others. For depositing hard-facing materials of high purity, on two or three-dimensional substrates, CVD and ALD processes may be desirable because they can give high levels of purity, often with good conformal step coverage on highly non-planar geometries, such as the uplift portions of the mower blade.

Many modifications and other embodiments of the invention set forth herein will come to mind to one skilled in the art to which this invention pertain shaving the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A mower blade, comprising:
a body portion formed from a base metal layer having a first hardness, wherein the body portion includes a top surface, a bottom surface, a first side edge, a second side edge, and an aperture configured to mount the mower blade to a rotary power output of a mower to provide the body rotary movement, the aperture dividing the body portion into a first end and a second end;
the first end including the first side edge and a first leading edge including a first cutting edge arranged opposite a first trailing edge, the first trailing edge having a first upturned portion;
the second end including the second side edge and a second leading edge including a second cutting edge arranged opposite a second trailing edge, the second trailing edge having a second upturned portion; and
a hard-facing material having a second hardness and disposed on the first cutting edge, the second cutting edge, and at least a portion of the top surface; wherein the second hardness is larger than the first hardness.

2. The mower blade of claim 1, wherein the hard-facing material is disposed on first side edge, the second side edge, or both.

3. The mower blade according to claim 1, wherein a first distance between the aperture and the first side edge defines a first length, and wherein the hard-facing material is disposed on the top surface and defines a first coating area extending from the first leading edge to the first trailing edge and from the first side edge inwardly towards the aperture along 10% to 100% of the first length.

4. The mower blade of claim 3, wherein the hard-facing material is disposed on the top surface and defines a first coating area extending from the first leading edge to the first trailing edge and from the first side edge inwardly towards the aperture along 20% to 60% of the first length.

5. The mower blade according to claim 4, wherein a second distance between the aperture and the second side edge defines a second length, and wherein the hard-facing material is disposed on the top surface and defines a second coating area extending from the second leading edge to the second trailing edge and from the second side edge inwardly towards the aperture along 10% to 100% of the second length.

6. The mower blade of claim 5, wherein the hard-facing material is disposed on the top surface and defines a second coating area extending from the second leading edge to the second trailing edge and from the second side edge inwardly towards the aperture along 20% to 60% of the second length.

7. The mower blade according to claim 1, wherein the top surface includes a first top surface portion and the first upturned portion define a first lift portion, wherein from about 10 to about 100% of the first top surface portion has the hard-facing material disposed thereon.

8. The mower blade according to claim 1, wherein the top surface includes a second top surface portion and the second upturned portion define a second lift portion, wherein from about 10 to about 100% of the second top surface portion has the hard-facing material disposed thereon.

9. The mower blade according to claim 1, wherein the first uplift portion has a first uplift angle (α) of 20 to 60 degrees as measured from (i) a first imaginary line (L1) that starts at a first point (P1) defined by the intersection of the first cutting edge and the first side edge and extends towards the first trailing edge alone an imaginary plane that is parallel to a planar central body portion surrounding the aperture of the body portion, and (ii) a second imaginary line (L2) that starts at the first point (P1) and extends in a straight path to an uppermost point (P2) of the first upturned portion.

10. The mower blade according to claim 9, wherein the second uplift portion has a second uplift angle that is the same as the first uplift angle.

11. The mower blade according to claim 1, wherein the first cutting edge extends inwardly from the first side edge and comprises from 10 to about 70% of first leading edge, and wherein the hard-facing material is disposed onto the first cutting edge.

12. The mower blade according to claim 1, wherein the second cutting edge extends inwardly from the second side edge and comprises from 10 to about 70% of second leading edge, and wherein the hard-facing material is disposed onto the second cutting edge.

13. The mower blade according claim 1, wherein the hard-facing material has an average thickness from about 50 microns to about 3000 microns.

14. The mower blade according to claim 1, wherein the hard-facing material deposited onto the first cutting edge, the second cutting edge or both has a first average thickness; and the hard-facing material deposited onto the top surface of the first uplift portion, the second uplift portion, or both has a second average thickness, wherein the first average thickness is the same or larger than the second average thickness.

15. The mower blade according to anyone of claim 14, wherein the hard-facing material deposited onto planar portions of the top surface that are parallel to a ground being traversed has a third average thickness that is smaller than the first average thickness, the second average thickness, or both.

16. The mower blade according to claim 14, further comprising a first ratio between the first average thickness and the second average thickness is from 1:1 to 10:1.

17. The mower blade according to claim 14, further comprising a second ratio between the second average thickness and the third average thickness is from 1:1 to 10:1.

18. The mower blade according to claim 1, wherein the hard-facing material comprises tungsten carbide, tungsten carbide having a cobalt content, boron carbide, nickel bonded carbide, stellite, titanium carbide, chrome carbide, iron carbide, diamond, ceramics, or combinations thereof.

19. A lawn mower, comprising: an motor coupled to a rotary power output, and mower blade according to claim 1 coupled to the rotary power output.

20. A method of producing a mower blade, comprising: providing or forming a body portion from a base metal layer having a first hardness, wherein the body portion includes a top surface, a bottom surface, a first side edge, a second side edge, and an aperture configured to mount the mower blade to a rotary power output of a mower to provide the body rotary movement, the aperture dividing the body portion into a first end and a second end;
the first end including the first side edge and a first leading edge including a first cutting edge arranged opposite a first trailing edge, the first trailing edge having a first upturned portion;
the second end including the second side edge and a second leading edge including a second cutting edge arranged opposite a second trailing edge, the second trailing edge having a second upturned portion; and
depositing a hard-facing material having a second hardness on the first cutting edge, the second cutting edge, and at least a portion of the top surface; wherein the second hardness is larger than the first hardness to produce a mower blade according claim 1.
